(19) United States
(12) Patent Application Publication
(10) Pub. No.: US 2007/0243995 A1
(43) Pub. Date: Oct. 18, 2007

(54) Corrosion-Resistant Fiberglass-Reinforced Plastic Material

(76) Inventors: Eric Dallies, La Ravoire (FR); Anne Berthereau, Challes Les Eaux (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/630,400

(22) PCT Filed: Jun. 24, 2005
(86) PCT No.: PCT/FR05/50489

§ 371 Date: Jan. 30, 2007

(30) Foreign Application Priority Data
Jun. 24, 2004 (FR) 0406949

(51) Int. Cl. C04B 35/14

(52) U.S. Cl. 501/135

(57) ABSTRACT

The present invention relates to the use of glass reinforcing yarns of given composition for obtaining plastics with improved resistance to corrosive, especially basic and acid, substances. It also relates to the composites comprising a plastic reinforced by such glass yarns.

The invention relates to the use of glass yarns for the reinforcement of plastics, the said yarns having an improved resistance to corrosive substances, especially bases and acids.

Plastics are used in various fields, for example to form parts of all kind, whether structural parts or coatings, which are intended to be in contact with corrosive substances. It is well known that it is possible to improve the mechanical properties of these plastics by incorporating glass fibers into them and thus obtain reinforced parts more commonly called “composites”.

The yarns used at the surface of the composites are not all protected by the plastic that forms the matrix and those that are directly in contact with the corrosive substance are degraded over time. Moreover, the corrosive substance may diffuse into the matrix and thus reach the subjacent glass reinforcing yarns. It is accepted that the degradation of these yarns results from the dissolution of the glass by the corrosive substance and that the dissolution is more rapid the higher the content of corrosive substance.

When they are degraded, the glass yarns no longer provide their correct reinforcement function: the mechanical properties of the composite, especially the modulus, the tensile strength and the elongation at break, are reduced. The insufficiently reinforced plastic then undergoes local deformations resulting in fracture of the material and the release of the corrosive substance either directly into the external environment, if the plastic is used for structural parts such as pipes and tanks, or at the interface of the composite and the material to be protected, if the composite is employed as a coating.

The object of the present invention is to remedy the aforementioned drawbacks by proposing to improve the resistance of composites to corrosive substances by the addition of glass reinforcing yarns of the following composition, expressed in molar percentages:

| | |
|---|---|
| SiO₂ | 62-75 |
| ZrO₂ | 7-11 |
| Na₂O | 13-23 |
| R′O | 1-10 |
| Al₂O₃ | 0-4 |
| B₂O₃ | 0-6 |
| Fe₂O₃ | 0-5 |
| CaF₂ | 0-2 |
| TiO₂ | 0-4 |

in which:
R′O=alkaline-earth metal oxides+MnO+ZnO; and
the composition containing less than 0.1% K₂O and/or Li₂O.

The abovementioned 0.1% value is to be understood as representing the maximum content of K₂O and Li₂O provided as impurities by the batch materials used for producing the glass, and not as an intentional addition. Preferably, the glass composition contains no K₂O and Li₂O.

Conventionally, the glass yarns are obtained by mechanically drawing a multiplicity of glass streams flowing out from a bushing filled with molten glass so as to form filaments that are then gathered into at least one yarn, the said yarn generally being collected in the form of a package by means of a suitable device, such as a winder. There are several forms of presentation of the yarn: roving, chopped strand, continuous or chopped strand mat, mesh, veil, woven or knit.

Conventionally, the working range is defined by the difference between the forming temperature measured for a viscosity η equal to 10³ poise (denoted by T_{logη=3}) and the liquidus temperature (denoted by T_{liq}). Here it is at least 40° C., which is sufficient for the fiberizing to take place correctly, and is preferably at least 100° C. Furthermore, the forming temperature is at most 1320° C., preferably 1300° C. or lower, corresponding to a temperature that is quite acceptable as it does not require heating the glass excessively and making it possible to minimize the wear of the bushing.

Before they are gathered into a yarn or yarns, it is possible to combine the glass filaments with filaments of a thermoplastic organic material coming from a spinneret suitable for producing such filaments so as to form a composite yarn in which both types of filaments are intimately mingled. Processes used for obtaining such a yarn are described for example in EP-A 0 505 275, FR 2 674 260, EP-A-0 599 695, EP-A-0 616 055, WO 98/01751 and WO 02/31235. The maximum proportion of thermoplastic filaments in the final glass yarn is equal to 70% by weight. In most cases, the yarn contains no thermoplastic filaments.

The plastics that can be used within the context of the invention are thermoplastic or thermosetting, preferably thermosetting, organic materials.

As examples of thermoplastic organic materials, mention may be made of polyolefins, such as polyethylene, polypropylene and polybutylene, polyesters, such as polyethylene terephthalate and polybutylene terephthalate, polyamides, polyurethanes and blends of these compounds.

As examples of thermosetting organic materials, mention may be made of epoxy resins, polyesters, vinyl esters, phenolic resins, polyacrylics and blends of these compounds. Vinyl esters are preferred as they exhibit better corrosion resistance.

The glass yarns are generally incorporated into the plastic in a proportion such that the glass represents 15 to 80% by volume, preferably 20 to 60% by volume, of the composite.

The presentation of the glass yarns depends on the nature of the plastic used and on the process employed. It is possible to use glass yarns in the form of continuous strands (for example in the form of cakes or rovings) or chopped strands, continuous or chopped strand mat, meshes, veils, wovens or knits.

For example, continuous strands are used for applications that are carried out by filament winding (deposition of the reinforcement impregnated with plastic(s) on a mandrel rotating about its axis) or by pultrusion (passage of the reinforcement impregnated with plastic(s) through a die). Chopped strands are suitable for the production of composites by contact molding.

In general, the plastic is used in the liquid state. Molded composites based on a thermoplastic may be obtained by blending the plastic, melted beforehand from powder or granules of variable size, with the glass yarns in a blending device and by transferring the blended compound into the mold. Molded composites based on a thermosetting material may be produced by transferring the uncured, liquid material directly into a mold containing the glass yarns.

The subject of the invention is also the composites formed from a matrix based on a plastic reinforced by the aforementioned glass yarns obtained by the processes described above of filament winding, pultrusion and molding. As already indicated, the composites may be in the form of pipes, for example for the collection and disposal of waste water, containers and tanks for the transportation and storage of chemicals, and corrosion protection coatings. The composites formed by pultrusion may be used as elements for the reinforcement of basic inorganic materials, more particularly cement. These reinforcement elements, of variable length and cross section, are known as “rebars”.

The use of the glass yarns of the invention for producing composites has made it possible to improve the resistance to both acid and basic corrosive media, which results in the increase over time of at least one mechanical property of the composites formed compared with the composites obtained from yarns made of another glass.

The example below illustrates the invention without however limiting it.

### EXAMPLE 1

Glass filaments 17 μm in diameter were obtained by drawing streams of molten glass having the following composition (in mol %):

| | |
|---|---|
| SiO₂ | 68.8 |
| ZrO₂ | 9.3 |
| Na₂O | 15.3 |
| CaO | 5.7 |
| Al₂O₃ | 0.1 |
| TiO₂ | 0.1 |
| CaF₂ | 0.5 |

Along their path, the filaments were coated with a conventional aqueous size before being assembled into yarns, which were wound in the form of rovings.

After drying at 130° C. for 12 hours, the yarns were used to produce composite sheets with parallel yarns according to the ISO 1268-5 standard. The reinforced resin was a vinyl ester resin sold under the reference “Derakane Momentum 411-350” by Dow Chemical, to which were added, per 100 parts by weight of vinyl ester resin, 1.5 parts of hardener sold under the reference “Trigonox 239” by Akzo, 0.08 parts of a cure accelerator sold under the reference “NL-63-100” by Akzo and 0.1 parts of an inhibitor sold under the reference “Promotor C” by Akzo.

The sheets contain 50% by weight of glass and have a thickness of 3 mm. They were then treated at 100° C. in order to accomplish the complete crosslinking of the resin. The edges of the sheet were protected by a layer of an epoxy resin 1 to 2 mm in thickness.

The sheets underwent a stress corrosion test under the following conditions: two identical sheets were subjected to a given constant stress in three-point bending in an acid solution (1N HCl; 25° C.) on the one hand, and a basic solution (1M NaOH; 50° C.) on the other, for a period of 100 hours.

The failure stress was equal to 900 MPa and 710 MPa in acid medium and basic medium, respectively.

### COMPARATIVE EXAMPLE 1

This example was obtained under the conditions of Example 1, but using yarns made of E-glass with the following composition (in mol %):

| | |
|---|---|
| SiO₂ | 57.7 |
| Na₂O | 0.6 |
| K₂O | 0.2 |
| CaO | 25.1 |
| MgO | 0.4 |
| Al₂O₃ | 9.1 |
| TiO₂ | 0.1 |
| B₂O₃ | 6.7 |
| Fe₂O₃ | 0.1 |

The failure stress in bending was equal to 200 MPa and 420 MPa in acid medium and basic medium, respectively.

### COMPARATIVE EXAMPLE 2

This example was obtained under the conditions of Example 1, but using yarns of boron-free E-glass with the following composition (in mol %):

| | |
|---|---|
| SiO₂ | 61.5 |
| Na₂O | 0.2 |
| K₂O | 0.2 |
| CaO | 25.3 |
| MgO | 5.0 |
| Al₂O₃ | 7.7 |
| Fe₂O₃ | 0.1 |

The failure stress in bending after acid treatment was 500 MPa.

1. The use of glass reinforcing yarns of the following composition, expressed in molar percentages:

| | |
|---|---|
| SiO₂ | 62-75 |
| ZrO₂ | 7-11 |
| Na₂O | 13-23 |
| R′O | 1-10 |
| Al₂O₃ | 0-4 |
| B₂O₃ | 0-6 |
| Fe₂O₃ | 0-5 |
| CaF₂ | 0-2 |
| TiO₂ | 0-4 |

in which:
R′O=alkaline-earth metal oxides+MnO+ZnO; and
the composition containing less than 0.1% K₂O and/or Li₂O to improve the resistance of plastics in contact with corrosive substances, especially bases or acids.

2. The use as claimed in claim 1, wherein the glass composition contains no K₂O and Li₂O.

3. The use as claimed in claim 1, wherein the glass has a working range defined by the difference between the forming temperature measured for a viscosity η equal to 10³ poise (T_{logη=3}) and the liquidus temperature (T_{liq}) of at least 40° C., preferably at least 100° C.

4. The use as claimed in claim 1, wherein the plastic is a thermoplastic or thermosetting organic material.

5. The use as claimed in claim 4, wherein the thermoplastic organic material is chosen from polyolefins, such as polyethylene, polypropylene and polybutylene, polyesters, such as polyethylene terephthalate and polybutylene terephthalate, polyamides, polyurethanes and blends of these compounds.

6. The use as claimed in claim 4, wherein the thermosetting organic material is chosen from epoxy resins, polyesters, vinyl esters, phenolic resins, polyacrylics and blends of these compounds.

7. The use as claimed in claim 1, wherein the glass yarn is in the form of a continuous or chopped strand, a continuous or chopped strand mat, a mesh, a veil, a woven or a knit.

8. The use as claimed in claim 1, wherein the glass content represents 10 to 75% by volume, preferably 20 to 60% by volume, of the composite.

9. A composite formed from a plastic reinforced by 20 glass yams obtained as claimed in claim 1.

10. The composite as claimed in claim 9, in the form of a pipe, a tank or a container, or a coating or a rebar.
